(19) United States
(12) Patent Application Publication
(10) Pub. No.: US 2021/0201445 A1
(43) Pub. Date: Jul. 1, 2021

(54) IMAGE CROPPING METHOD

(71) Applicant: BEIJING SANKUAI ONLINE TECHNOLOGY CO., LTD, Beijing (CN)

(72) Inventor: Liping KANG, Beijing (CN)

(21) Appl. No.: 17/199,067

(22) Filed: Mar. 11, 2021

Related U.S. Application Data
(63) Continuation of application No. PCT/CN2019/104966, filed on Sep. 9, 2019.

(30) Foreign Application Priority Data
Sep. 11, 2018 (CN) 201811058837.6

(51) Int. Cl. G06T 3/40; G06T 7/00; G06T 3/60; G06N 20/00

(52) U.S. Cl. CPC G06T 3/40; G06T 7/0002; G06T 3/60; G06T 2207/20081; G06T 2207/30168; G06T 2207/20132; G06N 20/00

(57) ABSTRACT

Disclosed is an image cropping method, which relate to the technical field of computers. An implementation of the method includes: generating a cropping frame according to a size of a to-be-cropped image and a target size; selecting image blocks from the to-be-cropped image by using the cropping frame; and evaluating the selected image blocks by using a composition quality evaluation model, and taking the image block with the highest evaluation score as a target image obtained by cropping.

### CROSS REFERENCE TO RELATED APPLICATIONS

This application is a continuation application of international application No. PCT/CN2019/104966, file on Sep. 9, 2019, which claims priority to Chinese Patent Application No. 201811058837.6, filed on Sep. 11, 2018 and entitled “IMAGE CROPPING METHOD AND APPARATUS”. Both applications are incorporated herein by reference in their entirety.

### TECHNICAL FIELD

This application relates to the field of computer technologies, and in particular, to an image cropping method.

### BACKGROUND

With the development of multimedia and mobile terminal technologies, abundant pictures may be produced every day. Ordinary users, magazine editors, new media editors and enterprise operators all need to crop pictures according to specific requirements. On the one hand, image composition is more reasonable, and on the other hand, image display needs to be performed through image cropping and transforming in a case that particular display size requirements are met.

### SUMMARY

Embodiments of this application provide an image cropping method.

According to one aspect of the embodiments of this application, an image cropping method is provided, including: generating a cropping frame according to a size of a to-be-cropped image and a target size; selecting image blocks from the to-be-cropped image by using the cropping frame; and evaluating the selected image blocks by using a composition quality evaluation model, and taking the image block with the highest evaluation score as a target image obtained by cropping.

According to yet another aspect of the embodiments of this application, an image cropping electronic device is provided, including: one or more processors; and a storage apparatus, configured to store one or more programs, the one or more programs, executed by the one or more processors, causing the one or more processors to perform: generating a cropping frame according to a size of a to-be-cropped image and a target size; selecting image blocks from the to-be-cropped image by using the cropping frame; and evaluating the selected image blocks by using a composition quality evaluation model, and taking the image block with the highest evaluation score as a target image obtained by cropping.

According to still another aspect of the embodiments of this application, a computer-readable medium storing a computer program is provided, the program, when executed by a processor, performing the following steps: generating a cropping frame according to a size of a to-be-cropped image and a target size; selecting image blocks from the to-be-cropped image by using the cropping frame; and evaluating the selected image blocks by using a composition quality evaluation model, and taking the image block with the highest evaluation score as a target image obtained by cropping.

### BRIEF DESCRIPTION OF THE DRAWINGS

The drawings are intended to better understand this application and do not constitute an undue limitation on this application. In the drawings,

FIG. 1 is a schematic diagram of main steps of an image cropping method according to an embodiment of this application;

FIG. 2 is a schematic diagram of an implementation process of one embodiment of this application;

FIG. 3 is a schematic diagram of an implementation process of another embodiment of this application;

FIG. 4 is a diagram of image cropping effects of a technical solution under different target sizes according to this application;

FIG. 5 is a comparison diagram of image cropping effects of the technical solution according to this application and a related technical solution;

FIG. 6 is a schematic diagram of main modules of an image cropping apparatus according to an embodiment of this application;

FIG. 7 is a diagram of an exemplary system architecture to which an embodiment of this application is applicable; and

FIG. 8 is a schematic structural diagram of a computer system suitable for a terminal device or server configured to implement an embodiment of this application.

### DETAILED DESCRIPTION

Exemplary embodiments of this application are described below with reference to the drawings, and various details of the embodiments of this application are included to facilitate understanding and should be considered exemplary only. Therefore, a person of ordinary skill in the art should be aware that a variety of changes and modifications can be made to the embodiments described here without departing from the scope and spirit of this application. Similarly, for clarity and conciseness, descriptions of well-known functions and structures are omitted in the following description.

Currently common image cropping methods are mostly automatic cropping based on GrabCut recognition (please refer to Patent Application No. CN107610131A). In the methods, during image cropping, firstly, a position of a GrabCut image of an image is determined, and then a cropping position is determined according to a golden position point of a cropping rectangle and a central position point of the GrabCut image to crop the image.

However, the solution of automatic cropping based on GrabCut recognition has the following problems:

1. In the solution, cropping can be performed only for a target size that meets a particular cropping condition, and an arbitrary target size cannot be dealt with.

2. There are controversies about the idea of determining a cropping position with an image GrabCut (characters, animals and plants): (1) how to define the GrabCut and how to deal with a category of a GrabCut that has never appeared; (2) for a multi-GrabCut image, the solution further needs to determine a core GrabCut, has some problems in technical implementation, and cannot guarantee the integrity of information and the rationality of global composition; and (3) reasonable cropping regions of pictures are not more reasonable in GrabCut display, but are related to content and composition of each image.

3. A composition rule of the solution is determined by fixed golden position points of nine-grid composition, and is irrelevant to image content and composition. Therefore, a GrabCut image determined during cropping is not accurate enough, resulting in incomplete cropping information.

Based on the above, image cropping by manpower is costly, and image results obtained by an automatic cropping technology based on GrabCut recognition at present are not satisfactory, such as incomplete cropping information and an unreasonable cropping region. Therefore, how to achieve automatic cropping of images of arbitrary target sizes to obtain as complete cropping information as possible and a more reasonable cropping region becomes particularly important.

An image cropping method according to an embodiment of this application is applicable to an electronic device. The electronic device is a mobile phone, a tablet computer, or the like. Moreover, the image cropping method is widely applicable to a variety of actual application scenarios. For example, the image cropping method is applicable to the following three scenarios:

(1) It is applicable to a shooting application: For example, in a case that an electronic device shoots an image through a camera application, the electronic device automatically crops the image, so that composition of the image is more reasonable. In another example, the electronic device determines whether composition of an image is reasonable before the image is taken through the camera application. If the composition of the image is unreasonable, the electronic device crops the image, so that the composition of the image is more reasonable. In another example, a user considers composition of a certain image in an image library of the electronic device as unreasonable, and the user manually triggers the electronic device to crop the image, so that the composition of the image is more reasonable.

(2) It is applicable to a social application: For example, in a case that the user sends an image to a friend through the social application, the electronic device is triggered to crop the image. In another example, in a case that the user uploads an image to an information display platform of the social application, the electronic device is triggered to crop the image.

(3) It is applicable to an information collection application: In a case that the user uploads an image in the information collection application, the electronic device crops the image, so that the cropped image meets display size requirements of the information collection application.

This application provides an image cropping method, which can automatically evaluate and score, according to content and composition of each image, image blocks selected through a cropping frame based on a composition quality evaluation model of the image, so as to obtain the most reasonable region of global composition, and can crop the image according to an arbitrary target size.

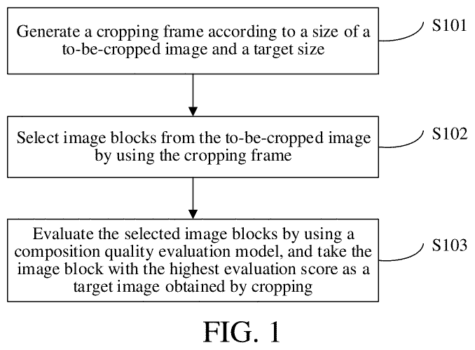

FIG. 1 is a schematic diagram of steps of an image cropping method according to an embodiment of this application. As shown in FIG. 1, the image cropping method according to the embodiment of the application includes step S101 to step S103 as follows.

Step S101: Generate a cropping frame according to a size of a to-be-cropped image and a target size.

Step S102: Select image blocks from the to-be-cropped image by using the cropping frame.

Step S103: Evaluate the selected image blocks by using a composition quality evaluation model, and take the image block with the highest evaluation score as a target image obtained by cropping.

According to step S101 to step S103 described above, intelligent cropping can be implemented according to content and composition of the to-be-cropped image, the selected image blocks are evaluated and scored based on the composition quality evaluation model, the problem of image multi-GrabCut cropping can be better resolved, and the rationality and aesthetics of image composition are fully considered, so as to acquire the most reasonable region of global composition.

In the embodiment of this application, the target size is a size of the target image obtained by cropping the to-be-cropped image, and is determined according to a service scenario. There may be different use scenarios in actual use, and thus the target size may be an arbitrary size. For example, when an image is displayed at different positions in application software, a corresponding target size may vary. Correspondingly, a display position of the to-be-cropped image is determined before the to-be-cropped image is cropped; and a size corresponding to the display position is determined as the target size.

According to one embodiment of this application, before the generating a cropping frame according to a size of a to-be-cropped image and a target size, first correction is performed on the size of the to-be-cropped image and the target size, that is, the size of the to-be-cropped image is updated to a size of the to-be-cropped image after the first correction and the target size is updated to a target size after the first correction; and after the taking the image block with the highest evaluation score as a target image obtained by cropping, that is, a size of the target image is adjusted to the target size before the first correction, and the target image is updated to the adjusted target image.

According to the technical solution of this application, there are no requirements or restrictions on the size of the to-be-cropped image and the size of the target image, and the sizes are not limited to regular graphics such as rectangles, circles and ellipses. The technical solution of this application can still be used for processing even if the to-be-cropped image and the target image obtained by cropping are irregular graphics. According to this application, first correction is performed on the size of the to-be-cropped image and the target size before image cropping, so that the size of the to-be-cropped image and the target size can be corrected to a size convenient for image cropping.

In general, during the image cropping, the size of the to-be-cropped image and the target size are corrected to a width and a height of a rectangle, so as to facilitate the image cropping. When the size of the to-be-cropped image and the target size are corrected to the width and the height of the rectangle, the to-be-cropped image and a size of a circumscribed rectangle of the target image obtained by cropping is calculated according to the size of the to-be-cropped image and the target size, and then the image cropping is performed according to the width and the height of the rectangle.

According to one embodiment of this application, in step S101, the generating a cropping frame is performed according to the following steps:

Step S1011: Scale the to-be-cropped image in a case that an aspect ratio of the to-be-cropped image remains unchanged, so that a length of one side of the scaled to-be-cropped image is equal to a length of a corresponding side of the target size, and a length of another side of the scaled to-be-cropped image is greater than a length of another side of the target size.

Step S1012: Take the one side of the scaled to-be-cropped image whose length is equal to the length of the corresponding side of the target size as one side of the cropping frame, and then generate the cropping frame according to the length of the another side of the target size.

During the scaling, one case is that a width of the scaled to-be-cropped image is equal to that of the target size, and a height of the scaled to-be-cropped image is greater than that of the target size; and the other case is that a height of the scaled to-be-cropped image is equal to that of the target size, and a width of the scaled to-be-cropped image is greater than that of the target size. One of the foregoing two cases depends on the width and the height of the to-be-cropped image and a target width and a target height.

According to one embodiment of this application, the scaling the to-be-cropped image is implemented according to the following steps:

obtaining a first scale by calculating a ratio of a width of the target size to a width of the to-be-cropped image, and obtaining a second scale by calculating a ratio of a height of the target size to a height of the to-be-cropped image;

determining a maximum value of the first scale and the second scale as a scale; and

scaling the to-be-cropped image according to the scale.

The step of scaling the to-be-cropped image according to the scale is: multiplying the size of the to-be-cropped image by the scale to obtain a size of the scaled to-be-cropped image.

For example, it is assumed that the width of the to-be-cropped image is w and the height is h and that the width of the target size is W and the height is H, the first scale is T1=(W/w), the second scale is T2=(H/h), and the scale T=max(T1, T2). When the to-be-cropped image is scaled according to the scale T, the size of the to-be-cropped image is multiplied by the scale T to obtain a size of the scaled to-be-cropped image.

According to the technical solution in one embodiment of this application, in response to that the aspect ratio of the target size is not in a preset aspect ratio range, before the scaling the to-be-cropped image in a case that an aspect ratio of the to-be-cropped image remains unchanged, second correction is performed on the target size, so that an aspect ratio of the target size after the second correction is equal to a target aspect ratio threshold that is in the preset aspect ratio range and closest to the aspect ratio of the target size, that is, the target size is updated to the target size after the second correction; and after the taking the image block with the highest evaluation score as a target image obtained by cropping, the size of the target image is adjusted to the target size before the second correction, that is, the target image is updated to the adjusted target image.

According to the technical solution in another embodiment of this application, in response to that a deformation scale is not in a preset deformation scale range, before the scaling the to-be-cropped image in a case that an aspect ratio of the to-be-cropped image remains unchanged, third correction is performed on the target size, so that a second deformation scale is equal to a target deformation scale, that is, the target size is updated to the target size after the third correction, the target deformation scale is a deformation scale threshold that is in the preset deformation scale and closest to the first deformation scale, the first deformation scale is a deformation scale obtained by dividing the aspect ratio of the to-be-cropped image by the aspect ratio of the target size, and the second deformation scale is a deformation scale obtained by dividing the aspect ratio of the to-be-cropped image by an aspect ratio of the target size after the third correction; and after the taking the image block with the highest evaluation score as a target image obtained by cropping, the size of the target image is adjusted to the target size before the third correction, that is, the target image is updated to the adjusted target image.

The correction (including the second correction and the third correction) on the target size refers to: correcting a long-side length of the target size according to a short-side length of the target size and an aspect ratio of the corrected target size.

In general, when the to-be-cropped image is cropped, the aspect ratio of the target size obtained by cropping being closer to the aspect ratio of the to-be-cropped image indicates more complete obtained image information and less image deformation.

In one embodiment of this application, during the image cropping, a preset aspect ratio range of the target size can be simply set in advance based on experience. In response to that the aspect ratio of the target size is not in the preset aspect ratio range, second correction is performed on the target size. In response to that the aspect ratio of the target size is in the preset aspect ratio range, a compromise between the deformation and the integrity of the image information is required. After the preset aspect ratio range is set, an aspect ratio threshold (the threshold is an upper limit of the preset aspect ratio range and a lower limit of the preset aspect ratio range) corresponding to the preset aspect ratio can be obtained. A process in which the target size is corrected is as follows, firstly, the aspect ratio of the target size is corrected to an aspect ratio threshold closest to the aspect ratio in the preset aspect ratio range, and then a long-side length of the target size is corrected according to a short-side length of the target size and an aspect ratio of the corrected target size. The aspect ratio of the target size is corrected to the aspect ratio threshold closest to the aspect ratio in the preset aspect ratio range, so that the integrity of the image information can be obtained by introducing as little deformation as possible.

In another embodiment of this application, in the image cropping process, whether the to-be-cropped image needs to be corrected is determined not only according to the aspect ratio of the target size, but also in consideration of an original aspect ratio of the image. For example, a first deformation scale is obtained by dividing the aspect ratio of the to-be-cropped image by the aspect ratio of the target size. In response to that a first deformation scale is not in a preset deformation scale range, third correction is performed on the target size. In this way, less deformation and higher information integrity of the target image obtained by cropping can be ensured. In another example, in response to that the first deformation scale is not in the preset deformation scale range, a compromise between the deformation and the integrity of the image information is required. After the preset deformation scale range is set, a corresponding deformation scale threshold may be obtained. Moreover, the deformation scale threshold of the preset deformation scale range is a scale and reciprocal of the scale respectively. For example, the preset deformation scale range is [1/T, T].

In another embodiment of this application, determining of the first deformation scale varies according to the aspect ratios of the to-be-cropped image. For example, in response to that the aspect ratio of the to-be-cropped image is greater than or equal to 1, dividing the aspect ratio of the to-be-cropped image by the aspect ratio of the target size to obtain the first deformation scale; and in response to that the aspect ratio of the to-be-cropped image is no greater than 1, dividing the aspect ratio of the to-be-cropped image by the aspect ratio of the target size to obtain the first deformation scale. Correspondingly, an implementation algorithm for the first deformation scale is, for example, assuming that the width of the to-be-cropped image is w and the height is h and that the width of the target size is W and the height is H;

if w/h>=1:

scale=(w/h)/(W/H)

else:
scale=(h/w)/(H/W);

If the first deformation scale is in a deformation scale range of [1/T, T], the target size is not corrected; and otherwise, the target size is corrected. The setting of the value of T needs to make a compromise between the deformation and the integrity of the image information. A process in which the target size is corrected is as follows, firstly, the deformation scale obtained by dividing the aspect ratio of the to-be-cropped image to the aspect ratio of the target size is corrected to a deformation scale threshold closest to the deformation scale; then, an aspect ratio of the corrected target size is obtained according to the corrected deformation scale and the aspect ratio of the to-be-cropped image; and finally, a long-side length of the target size is corrected according to a short-side length of the target size and the aspect ratio of the corrected target size.

With the judgment on the target size, a small amount of deformation can be introduced to correct (including the second correction and the third correction) a relatively extreme target size to obtain the integrity of the image information.

According to another embodiment of this application, in step S102, a process in which the image blocks are selected by using the cropping frame is: selecting, along the another side of the scaled to-be-cropped image, image blocks from the to-be-cropped image by using the cropping frame according to a cropping step. After the scaling, a length of one side of the scaled to-be-cropped image is equal to a length of a corresponding side of the target size, and a length of another side of the scaled to-be-cropped image is greater than a length of another side of the target size. Therefore, the selection of the image blocks according to the cropping step along the another side of the scaled to-be-cropped image can achieve uniform and continuous acquisition of image blocks with different content, so as to better cover all the content of the to-be-cropped image, which fully considers the rationality and aesthetics of image composition, so as to acquire the most reasonable region of global composition as the target image.

According to the embodiment of this application, the cropping step may be determined according to the number of to-be-selected image blocks. For the number N of the to-be-selected image blocks, an empirical value is selected based on experimental verification. A greater N indicates a smaller and more precise cropping step, but a greater calculation amount and a lower speed. On the contrary, a smaller N indicates a larger cropping step, a smaller calculation amount and a faster speed, but the accuracy of cropping of the to-be-cropped image by using the cropping frame is reduced. During implementation, the number of to-be-selected image blocks and the cropping step can be set according to accuracy requirements of the image cropping.

According to the embodiment of this application, in response to that a target width ratio is greater than or equal to a target height ratio, before the selecting image blocks from the to-be-cropped image by using the cropping frame, the to-be-cropped image is counterclockwise rotated by 90 degrees, so as to make the cropping frame select the image blocks in a horizontal direction, the target width ratio is a ratio of a width of the target size to a width of the to-be-cropped image, and the target height ratio is a ratio of a height of the target size to a height of the to-be-cropped image; and after the taking the image block with the highest evaluation score as a target image obtained by cropping, the target image is clockwise rotated by 90 degrees, and the target image is updated to the rotated target image. In response to that the target width ratio is greater than or equal to the target height ratio, the to-be-cropped image is rotated. That is, assuming that the width of the to-be-cropped image is w and the height is h and that the width of the target size is W and the height is H, the to-be-cropped image is rotated if W/w>=H/h.

In the embodiment of this application, the image is counterclockwise rotated by 90 degrees. Alternatively, the image is counterclockwise rotated by 270 degrees, or clockwise rotated by 90 degrees, or clockwise rotated by 270 degrees, so that the cropping frame selects the image blocks in a horizontal direction. Upon experimental verification, the selection of the image blocks in the horizontal direction by the cropping frame can avoid incomplete cropping information caused by the selection of the image blocks in a vertical direction by the cropping frame, and has a better effect especially on images with relatively single target regions on the horizontal line.

According to the technical solution in one embodiment of this application, the composition quality evaluation model is obtained in the following manner: constructing an image-cropped-image sample pair by using an image and a cropped image corresponding to the image, and then training the image-cropped-image sample pair based on a deep learning algorithm to obtain the composition quality evaluation model. Deep learning is a method based on representation learning of data in machine learning, which forms a more abstract high-level representation attribute category or feature by combining low-level features, so as to discover distributed feature representation of data. Since a deep convolutional neural network (CNN) has a better effect when applied to image recognition, in the embodiment of this application, the image-cropped-image sample pair is trained based on the deep CNN to obtain the composition quality evaluation model.

When sample training is performed based on the CNN to obtain the composition quality evaluation model, an image-cropped-image sample pair needs to be constructed first. A process in which the image-cropped-image sample pair needs to be constructed is as follows: statistics on a large amount of data of original images and corresponding cropping regions obtained after manual processing is counted, so that a corresponding correlation may be established between the original images and the cropping regions corresponding thereto to construct the image-cropped-image sample pair. The following two manners may be considered during the selection of the cropping region: a square region or an arbitrary boundary region.

Then, the constructed image-cropped-image sample pair is trained through the CNN to obtain the composition quality evaluation model. The process is as follows: feature extraction is performed through the CNN, a value obtained after an original image passes through a convolutional layer and a pooling layer (which are one or more) is taken as a feature vector of the original image, and a value obtained after a cropped image passes through the convolutional layer and the pooling layer (which are one or more) is taken as a feature vector of the cropped image. In order to facilitate feature comparison, for example, a size, the number, parameters, and a step of a filter in the convolutional layer and a size, the number, parameters, and a step of a filter in the pooling layer are designed to make a dimension size of the feature vector of the original image equal to a dimension size of the feature vector of the cropped image corresponding thereto. A loss function used during the sample training is, for example, hinge loss, and the loss function may be:

l(Iⱼ,Cⱼⁿ)=max{0,g+ϕ(Cⱼⁿ)−ϕ(Iⱼ)}

I denotes an original image, C denotes a cropped image of the original image, denotes a joint feature function, g denotes hamming loss, and it is assumed that composition of the original image is superior to that of the cropped image.

Similarly, the composition quality evaluation model in this application is not limited to the deep learning method, or evaluate the rationality of the image composition with a conventional method. According to the technical solution in another embodiment of this application, the composition quality evaluation model is obtained in the following manner: extracting an underlying feature reflecting image composition, then training an image classifier based on the underlying feature, and taking the image classifier as the composition quality evaluation model. For example, firstly, conventional underlying features reflecting the image composition such as HSV-color (hue, saturation, value), textures, blur, dark channel, and contrasts are extracted, and then an image classifier (e.g., a support vector machine (SVM) image classifier) is trained based on the underlying features to serve as the composition quality evaluation model. This may be simplified to binary classification of whether the composition is reasonable, and a probability value finally predicted as high composition quality may be considered as a score of the composition rationality thereof.

The method for training the composition quality evaluation model in this application is not limited to the examples listed above, and a person skilled in the art may train the composition quality evaluation model with different methods according to requirements.

An implementation process of this application is introduced below with reference to embodiments.

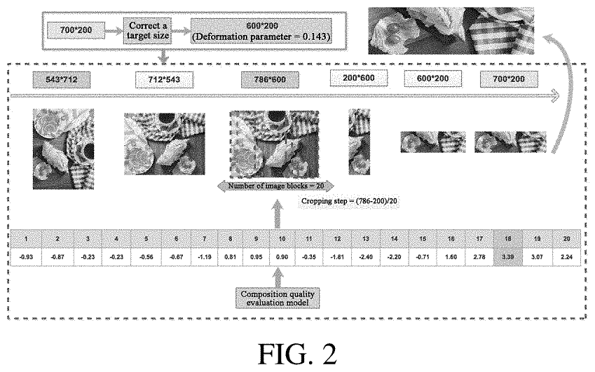

FIG. 2 is a schematic diagram of an implementation process of one embodiment of this application. In this embodiment, the size of the to-be-cropped image and the target size are both a width and a height of a rectangle. The size of the to-be-cropped image is 543 wide (in pixels, millimeters, or other length units) and 712 high, and the target size is 700 wide and 200 high. It is assumed that a preset aspect ratio range is [1:3, 3:1] with an example in which it is determined according to the aspect ratio of the target size whether the target size needs to be corrected. The aspect ratio of the target size is (700/200) greater, and if the target region is directly found on the to-be-cropped image according to the ratio, it may result in that the height cannot include relatively complete information. Therefore, the target size needs to be corrected. A correction process is: firstly, correcting the aspect ratio of the target size to an aspect ratio threshold, i.e. 3:1, closest to the aspect ratio in a preset aspect ratio range; and then calculating a long-side length of the corrected target size as 200*3=600 according to an aspect ratio of the corrected target size and a short-side length of the target size. So, the corrected target size is 600 wide and 200 high.

Upon experimental verification, the selection of the image blocks in the horizontal direction by the cropping frame can avoid incomplete cropping information caused by the selection of the image blocks in a vertical direction by the cropping frame, and has a better effect especially on images with relatively single target regions on the horizontal line. Therefore, before the to-be-cropped image is scaled, it may be first determined whether the to-be-cropped image needs to be rotated and transformed. In response to that a target width ratio is greater than a target height ratio, it is determined that the to-be-cropped image needs to be rotated and transformed, the target width ratio is a ratio of a width of the target size to a width of the to-be-cropped image, and the target height ratio is a ratio of a height of the target size to a height of the to-be-cropped image. In response to that the target width ratio is greater than the target height ratio, it is determined that the to-be-cropped image does not need to be rotated and transformed. Moreover, after the to-be-cropped image is rotated and transformed, a target image corresponding to the corrected target size is also rotated and transformed.

For example, in this embodiment, since the ratio (700/543) of the width of the target size to the width of the to-be-cropped image is greater than the ratio (200/712) of the height of the target size to the height of the to-be-cropped image, the to-be-cropped image needs to be rotated and transformed.

A rotation manner of rotating and transforming the to-be-cropped image is: counterclockwise rotating the to-be-cropped image by 90 degrees or clockwise rotating the to-be-cropped image by 270 degrees, or clockwise rotating the to-be-cropped image by 90 degrees or counterclockwise rotating the to-be-cropped image by 270 degrees. Moreover, a rotation manner for the target image corresponding to the corrected target size is also the same as the rotation manner for the to-be-cropped image, that is, the rotation manner for the target image corresponding to the corrected target size is counterclockwise rotating the target image by 90 degrees or clockwise rotating the target image by 270 degrees, or clockwise rotating the target image by 90 degrees or counterclockwise rotating the target image by 270 degrees.

For example, in this embodiment, the size of the rotated to-be-cropped image is 712 wide and 543 high. Correspondingly, the target image corresponding to the corrected target size also needs to be counterclockwise rotated by 90 degrees, that is, the rotated target size is 200 wide and 600 high.

Afterwards, the to-be-cropped image is scaled in a case that an aspect ratio of the to-be-cropped image remains unchanged, so that a length of one side of the scaled to-be-cropped image is equal to a length of a corresponding side of the target size, and a length of another side of the scaled to-be-cropped image is greater than a length of another side of the target size. After the to-be-cropped image is rotated, the width of the target size is 200, the width of the to-be-cropped image is 712, and thus a first scale T1=200/712. The height of the target size is 600, the height of the to-be-cropped image is 543, and thus a second scale T2=600/543. Therefore, a scale T=max(T1, T2)=600/543. So, a size of the scaled to-be-cropped image is: 712×(600/543)=786 wide and 543×(600/543)=600 high. In this way, the size of the rotated to-be-cropped image can be transformed into an image with a height the same as the target height (600) after rotation and a width greater than the target width (200) after rotation, to facilitate sliding the cropping frame to select image blocks. When the to-be-cropped image is scaled, it is necessary to ensure that the aspect ratio of the to-be-cropped image remains unchanged, to ensure that the to-be-cropped image does not deform or lose information.

A person skilled in the art should know that the processing of rotating and transforming the to-be-cropped image and the processing of scaling the to-be-cropped image may be operated in an order different from the above order, which has no influence on an implementation effect of this application.

After the processing of rotating and transforming the to-be-cropped image and the processing of scaling the to-be-cropped image, a cropping frame is generated. A cropping frame on the processed to-be-cropped image (786 wide and 600 high) may be generated by taking one side (i.e. height) of the processed to-be-cropped image equal to a length of a corresponding side of the processed target size as one side of the cropping frame and a length of another side (i.e. wide) of the processed target size as another side of the cropping frame. As shown in FIG. 2, in this embodiment, the size of the cropping frame is 200 wide and 600 high, and the generated cropping frame is located at a left or right end of the processed to-be-cropped image.

Then, along the another side (i.e. width, horizontal direction) of the processed to-be-cropped image, image blocks are selected from the processed to-be-cropped image by using the cropping frame according to a cropping step. The cropping step is a distance each time the cropping frame is moved, for example, a value of a distance between the same vertexes of the cropping frame after each move and the cropping frame before the move. The cropping step depends on the number N of to-be-selected image blocks. After lots of experimental verification, the value of N is, for example, 20. Then, the cropping step=(786-200)/20=29.3. N different image blocks can be selected by moving the cropping frame.

Afterwards, the selected N image blocks are evaluated, and the image block with the highest evaluation score is determined as a target image obtained after cropping. The N image blocks may be evaluated by using a pre-trained composition quality evaluation model. As shown in FIG. 2, the 18^{th} image block has the highest score, which is 3.39, so the 18^{th} image block is the target image (200 wide and 600 high) obtained after cropping.

Before cropping, the to-be-cropped image is also rotated and transformed, i.e. counterclockwise rotated by 90 degrees. Therefore, after the target image is obtained, the target image also needs to be reversely rotated and transformed, i.e. clockwise rotated by 90 degrees, to obtain a target image (600 wide and 200 high) with the same size as the corrected target size.

Finally, since the target size is initially corrected, the size of the rotated and transformed target image also needs to be adjusted (image stretching) by adjusting the width to 700, to obtain a target image (700 wide and 200 high) corresponding to the target size.

Similarly, the process of rotating and transforming the target image obtained by cropping and the processing of image-stretching the target image obtained by cropping may also be operated in an order different from the above order, and are different only in stretching directions during image stretching. For example, image stretching is first performed and rotation transformation is then performed, the height of the target image obtained after cropping is adjusted to 700 to achieve the image stretching.

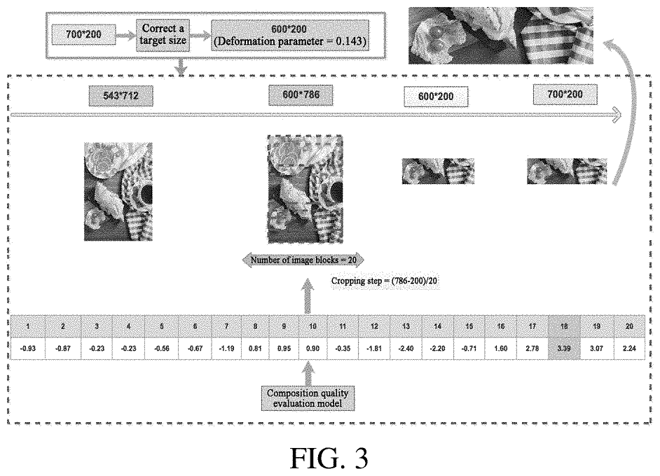

FIG. 3 is a schematic diagram of an implementation process of another embodiment of this application. In this embodiment, the size of the to-be-cropped image, the target size and the preset aspect ratio range are all the same as those in the embodiment shown in FIG. 2, and are different only in processing processes. A main difference lies in that before the to-be-cropped image is cropped, the image does not need to be rotated and transformed, and correspondingly, after a target image obtained after cropping is acquired, the image does not need to be reversely rotated and transformed. Moreover, in this embodiment, the size of the cropping frame is 600 wide and 200 high, and the generated cropping frame is located at a top end or a bottom end of the processed to-be-cropped image. The image blocks are selected in a vertical direction. Other processing processes the same as those in the embodiment shown in FIG. 2 are not described in detail herein.

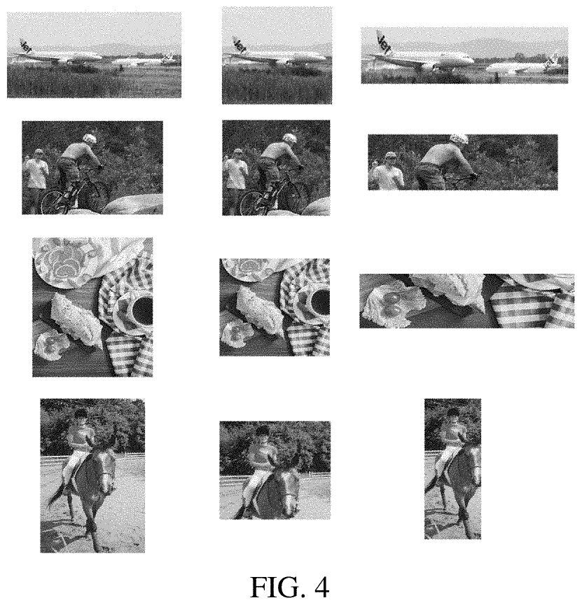

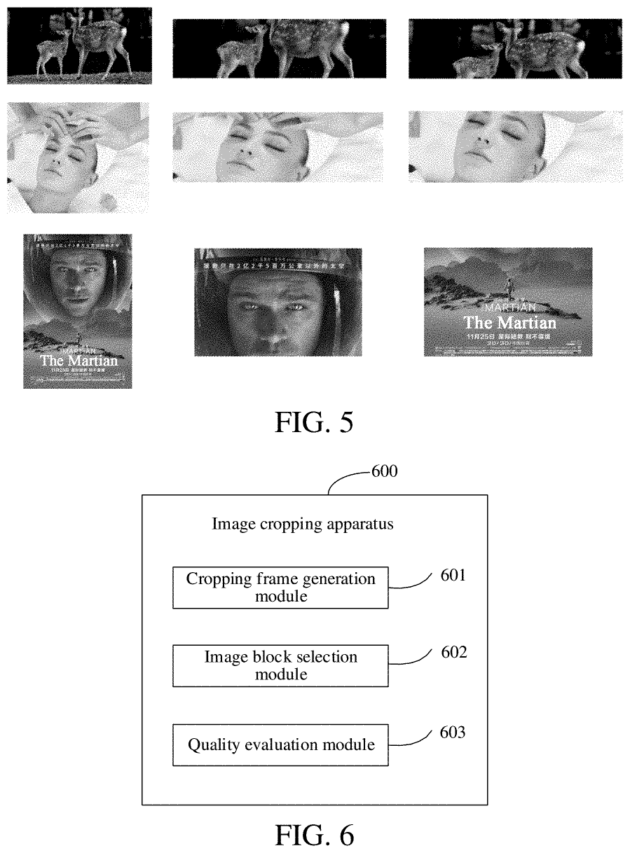

In order to have a more intuitive understanding of the implementation effect of this application, the following is a detailed description based on FIG. 4 and FIG. 5.

FIG. 4 is a diagram of image cropping effects of a technical solution under different target sizes according to this application. As can be seen from FIG. 4, regional composition of the target image obtained after cropping is reasonable regardless of the target size, and information integrity is high.

FIG. 5 is a comparison diagram of image cropping effects of the technical solution according to this application and a related technical solution. FIG. 5 shows effect comparisons between the technical solution according to this application and a GrabCut-based image cropping technical solution in the related art. The first column is a to-be-cropped image, the second column is a GrabCut-based image cropping result, and the third column is an image cropping result based on the technical solution of this application.

The first row is comparisons between image cropping effects including a plurality of GrabCuts. A GrabCut-based image cropping method takes more account of a most dominant region, and the cropping effect is not ideal in a case that a plurality of GrabCuts coexist. This application starts from the perspective of the rationality of global composition, and thus can better solve the problem of multi-GrabCut. The second row is comparisons between image sharpness. Obviously, the cropping region obtained with the method in this application is clearer than with the GrabCut-based image cropping method. The third row is comparisons between the rationality of content of image cropping. Reasonable image cropping is not simply displaying a GrabCut. As in this embodiment, if the GrabCut is taken as a basis for cropping, it is easy to obtain the result shown in the second column, with a head region displayed. However, From the perspective of the content reflected by the image, it is intended to convey information and a scene of a film. Therefore, the result based on global content information in the third column is obviously more reasonable than the result obtained by GrabCut-based cropping in the second column.

FIG. 6 is a schematic diagram of main modules of an image cropping apparatus according to an embodiment of this application. As shown in FIG. 6, an image cropping apparatus 600 according to the embodiment of this application mainly includes a cropping frame generation module 601, an image block selection module 602 and a quality evaluation module 603.

The cropping frame generation module 601 is configured to generate a cropping frame according to a size of a to-be-cropped image and a target size.

The image block selection module 602 is configured to select image blocks from the to-be-cropped image by using the cropping frame.

The quality evaluation module 603 is configured to evaluate the selected image blocks by using a composition quality evaluation model, and take the image block with the highest evaluation score as a target image obtained by cropping.

According to one embodiment of this application, the image cropping apparatus 600 further includes a first size correction module (not shown in the figure), configured to: perform first correction on the size of the to-be-cropped image and the target size; and adjust a size of the target image to the target size before the first correction.

Specifically, the first size correction module is further configured to: correct the size of the to-be-cropped image and the target size to a width and a height of a rectangle.

According to one embodiment of this application, the cropping frame generation module 601 is further configured to: scale the to-be-cropped image in a case that an aspect ratio of the to-be-cropped image remains unchanged, so that a length of one side of the scaled to-be-cropped image is equal to a length of a corresponding side of the target size, and a length of another side of the scaled to-be-cropped image is greater than a length of another side of the target size; and take the one side of the scaled to-be-cropped image whose length is equal to the length of the corresponding side of the target size as one side of the cropping frame, and then generate the cropping frame according to the length of the another side of the target size.

The cropping frame generation module 601 is further configured to: obtain a first scale by calculating a ratio of a width of the target size to a width of the to-be-cropped image, and obtain a second scale by calculating a ratio of a height of the target size to a height of the to-be-cropped image; determine a maximum value of the first scale and the second scale as a scale; and scale the to-be-cropped image according to the scale.

According to another embodiment of this application, the image cropping apparatus 600 further includes a second size correction module (not shown in the figure), configured to: in response to that the aspect ratio of the target size is not in a preset aspect ratio range, perform second correction on the target size, so that an aspect ratio of the target size after the second correction is equal to a target aspect ratio threshold, and the target aspect ratio threshold is an aspect ratio threshold that is in the preset aspect ratio range and closest to the aspect ratio of the target size, that is, update the target size to the target size after the second correction; and adjust the size of the target image to the target size before the second correction, that is, update the target image to the adjusted target image.

According to yet another embodiment of this application, the image cropping apparatus 600 further includes a third size correction module (not shown in the figure), configured to: in response to that a first deformation scale is not in a preset deformation scale range, perform third correction on the target size, so that a second deformation scale is equal to a target deformation scale threshold, that is, update the target size to the target size after the third correction, the target deformation scale is a deformation scale threshold that is in the preset deformation scale and closest to the first deformation scale, the first deformation scale is a deformation scale obtained by dividing the aspect ratio of the to-be-cropped image by the aspect ratio of the target size, and the second deformation scale is a deformation scale obtained by dividing the aspect ratio of the to-be-cropped image by an aspect ratio of the target size after the third correction; and adjust the size of the target image to the target size before the third correction, that is, update the target image to the adjusted target image.

According to another embodiment of this application, the image block selection module 602 may be further configured to: select, along the another side of the scaled to-be-cropped image, image blocks from the to-be-cropped image by using the cropping frame according to a cropping step.

According to the embodiment of this application, the cropping step is calculated according to the number of to-be-selected image blocks.

According to still another embodiment of this application, the image cropping apparatus 600 further includes an image rotating module (not shown in the figure), configured to: in response to a target width ratio is greater than or equal to a target height ratio, counterclockwise rotate the to-be-cropped image by 90 degrees, so as to make the cropping frame select the image blocks in a horizontal direction, the target width ratio is a ratio of a width of the target size to a width of the to-be-cropped image, and the target height ratio is a ratio of a height of the target size to a height of the to-be-cropped image; and clockwise rotate the target image by 90 degrees, that is, update the target image to the rotated target image.

According to one embodiment of this application, the composition quality evaluation model is obtained in the following manner:

constructing an image-cropped-image sample pair by using an image and a cropped image corresponding to the image, and then training the image-cropped-image sample pair based on a deep learning algorithm to obtain the composition quality evaluation model.

According to another embodiment of this application, the composition quality evaluation model is obtained in the following manner:

extracting an underlying feature reflecting image composition, then training an image classifier based on the underlying feature, and taking the image classifier as the composition quality evaluation model.

According to the technical solution in the embodiment of this application, a cropping frame is generated according to a size of a to-be-cropped image and a target size, image blocks are selected from the to-be-cropped image by using the cropping frame, and finally the selected image blocks are evaluated by using a composition quality evaluation model, which achieves intelligent cropping according to content and composition of the to-be-cropped image, and can better resolve the problem of image multi-GrabCut cropping and fully consider the rationality and aesthetics of image composition, so as to acquire the most reasonable region of global composition. The size of the to-be-cropped image and the target size are corrected, so that it is easy to crop images of arbitrary sizes. A scale of the target size is determined, some relatively extreme target sizes are corrected, and a small amount of deformation is introduced to exchange for the integrity of image information, so that the target image obtained by cropping can compromise between the deformation and the integrity of the image information. Some to-be-cropped images meeting a particular condition are rotated and transformed so that the cropping frame selects image blocks in a horizontal direction, which can avoid incomplete cropping information caused by the selection of the image blocks in a vertical direction by the cropping frame, and has a better effect especially on images with relatively single target regions on the horizontal line.

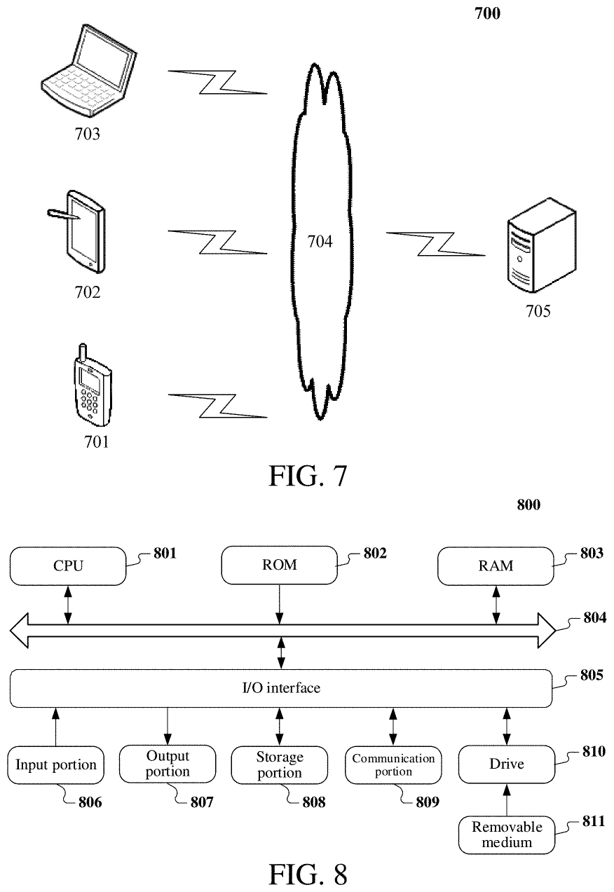

FIG. 7 shows an exemplary system architecture 700 to which the image cropping method or image cropping apparatus according to the embodiment of this application is applicable. As shown in FIG. 7, the system architecture 700 includes terminal devices 701, 702 and 703, a network 704 and a server 705. The network 704 is a medium configured to provide a communication link between the terminal devices 701, 702 and 703 and the server 705. The network 704 includes various connection types such as wired and wireless communication links or fiber optic cables.

A user uses the terminal devices 701, 702 and 703 to interact with the server 705 through the network 704, to receive or transmit messages or the like. The terminal devices 701, 702 and 703 are provided with various communication client applications such as a shopping application, a web browser application, a search application, an instant messaging tool, an e-mail client and social platform software (for example only).

The terminal devices 701, 702 and 703 are various electronic devices with a display screen and support web browsing, including, but not limited to, smartphones, tablets, laptops, desktop computers, and the like.

The server 705 is a server providing various services, for example, a backend administration server (for example only) supporting shopping websites browsed by the user with the terminal devices 701, 702 and 703. The backend administration server is configured to analyze data such as a received product information query request, and feed back processing results (such as target push information and product information; only for example) to the terminal device.

It is to be noted that the image cropping method according to the embodiment of this application is performed by the server 705 or performed by the terminal devices 701, 702 and 703. Correspondingly, the image cropping apparatus is generally disposed in the server 705 or in the terminal devices 701, 702 and 703.

It is to be understood that the number of the terminal devices, the number of the network, and the number of the server in FIG. 7 are merely exemplary. According to implement requirements, the system architecture 700 is provided with any number of terminal devices, networks, and servers.

Refer to FIG. 8 below which is a schematic structural diagram of a computer system 800 suitable for a terminal device or server configured to implement an embodiment of this application. The terminal device or server shown in FIG. 8 is merely an example, and does not impose any limitation on the functionality or scope of use of the embodiment of this application.

As shown in FIG. 8, the computer system 800 includes a central processing unit (CPU) 801. The CPU 801 performs various appropriate actions and processing according to a program stored in a read-only memory (ROM) 802 or a program loaded from a storage portion 808 into a random access memory (RAM) 803. Various programs and data required by operations of the system 800 are also stored in the RAM 803. The CPU 801, the ROM 802, and the RAM 803 are connected to each other through a bus 804. An input/output (I/O) interface 805 is also connected to the bus 804.

The following members are connected to the I/O interface 805: an input portion 806 including a keyboard, a mouse, and the like; an output portion 807 including, such as, a cathode ray tube (CRT), a liquid crystal display (LCD), and a loudspeaker; the storage portion 808 including a hard disk or the like; and a communication portion 809 including a network interface card such as an LAN card and a modem. The communication portion 809 performs communication processing over a network such as the Internet. A drive 810 is also connected to the I/O interface 805 as required. A removable medium 811, such as a disk, an optical disc, a magneto-optical disc, or a semiconductor memory, is installed on the drive 810 as required, so that a computer program read from the removable medium 811 is installed in the storage portion 808 as required.

In particular, according to the embodiment disclosed in this application, the process described above with reference to the flowchart can be implemented as a computer software program. For example, an embodiment disclosed in this application includes a computer program product. The computer program product includes a computer program hosted on a computer-readable medium. The computer program includes program code for performing the method shown in the flowchart. In such an embodiment, the computer program can be downloaded and installed from the network through the communication portion 809, and/or installed from the removable medium 811. The computer program, when executed by the CPU 801, performs the foregoing functions defined in the system of this application.

It is to be noted that the computer-readable medium according to this application is a computer-readable signal medium or a computer-readable storage medium or any combination of the two media. The computer-readable storage medium is, for example, but is not limited to, an electric, magnetic, optical, electromagnetic, infrared, or semi-conductive system, apparatus, or component, or any combination of the above. The computer-readable storage medium includes, for example, but is not limited to, an electrical connection having one or more wires, a portable computer disk, a hard disk, an RAM, an ROM, an erasable programmable read-only memory (EPROM or flash memory), an optical fiber, a portable compact disc read-only memory (CD-ROM), an optical storage device, a magnetic storage device, or any suitable combination of the foregoing. In this application, the computer-readable storage medium is any tangible medium containing or storing a program, and the program is used by or used in combination with an instruction execution system, an apparatus, or a device. In this application, a computer-readable signal medium includes a data signal being in a baseband or propagated as a part of a carrier wave, the data signal carrying computer-readable program code. A data signal propagated in such a way assumes a plurality of forms, including, but not limited to, an electromagnetic signal, an optical signal, or any appropriate combination thereof. The computer-readable signal medium is any computer readable medium in addition to a computer-readable storage medium. The computer readable medium sends, propagates, or transmits a program that is used by or used in conjunction with an instruction execution system, an apparatus, or a device. Program code embodied on the computer-readable medium is transmitted using any appropriate medium, including, but not limited to, wireless, wire, optical cable, radio frequency (RF) media, and the like, or any suitable combination of the foregoing.

The flowcharts and block diagrams in the accompanying drawings illustrate possible system architectures, functions and operations that can be implemented by a system, a method, and a computer program product according to various embodiments of this application. In this regard, each box in a flowchart or a block diagram represents a module, a program segment, or a part of code. The module, the program segment, or the part of code includes one or more executable instructions used for implementing designated logic functions. In some implementations used as substitutes, functions annotated in boxes can alternatively occur in a sequence different from that annotated in an accompanying drawing. For example, actually two boxes shown in succession can be performed basically in parallel, and sometimes the two boxes can be performed in a reverse sequence. This is determined by a related function. It should also be noted that, each box in a block diagram and/or a flowchart and a combination of boxes in the block diagram and/or the flowchart can be implemented by using a dedicated hardware-based system configured to perform a specified function or operation, or is implemented by using a combination of dedicated hardware and a computer instruction.

The units or modules described in the embodiments of this application can be implemented by means of software or hardware. Alternatively, the units or modules is disposed in a processor, which, for example, the process is described as: a processor including a cropping frame generation module, an image block selection module, and a quality evaluation module. Names of the units or modules do not limit the units or modules per se in some cases. For example, the cropping frame generation module is described as “a module configured to generate a cropping frame according to a size of a to-be-cropped image and a target size”.

As another aspect, this application further provides a computer-readable medium. The computer-readable medium is the computer-readable medium included in the device described in the foregoing embodiments, or a stand-alone computer-readable medium not assembled into the device. The computer-readable medium stores one or more programs. When the one or more programs are executed by the device, the device is caused to: generate a cropping frame according to a size of a to-be-cropped image and a target size; select image blocks from the to-be-cropped image by using the cropping frame; and evaluate the selected image blocks by using a composition quality evaluation model, and take the image block with the highest evaluation score as a target image obtained by cropping.

According to the technical solution in the embodiment of this application, a cropping frame is generated according to a size of a to-be-cropped image and a target size, image blocks are selected from the to-be-cropped image by using the cropping frame, and finally the selected image blocks are evaluated by using a composition quality evaluation model, which achieves intelligent cropping according to content and composition of the to-be-cropped image, and can better resolve the problem of image multi-GrabCut cropping and fully consider the rationality and aesthetics of image composition, so as to acquire the most reasonable region of global composition. The size of the to-be-cropped image and the target size are corrected, so that it is easy to crop images of arbitrary sizes. A scale of the target size is determined, some relatively extreme target sizes are corrected, and a small amount of deformation is introduced to exchange for the integrity of image information, so that the target image obtained by cropping can compromise between the deformation and the integrity of the image information. Some to-be-cropped images meeting a particular condition are rotated and transformed so that the cropping frame selects image blocks in a horizontal direction, which can avoid incomplete cropping information caused by the selection of the image blocks in a vertical direction by the cropping frame, and has a better effect especially on images with relatively single target regions on the horizontal line.

The foregoing implementations do not impose any limitation on the protection scope of this application. It is to be understood by a person skilled in the art that various modifications, combinations, sub-combinations and replacements can occur depending on design requirements and other factors. Any modification, equivalent replacement, improvement and the like made within the spirit and principle of this application all fall within the protection scope of this application.

In some implementations, the method further includes: before the generating a cropping frame according to a size of a to-be-cropped image and a target size, performing first correction on the size of the to-be-cropped image and the target size, and updating the size of the to-be-cropped image to the size after the first correction of the to-be-cropped image and the target size to the target size after the first correction; and after the taking the image block with the highest evaluation score as a target image obtained by cropping, adjusting a size of the target image to the target size before the first correction, and updating the target image to the adjusted target image.

In some implementations, the performing first correction on the size of the to-be-cropped image and the target size includes: correcting the size of the to-be-cropped image and the target size to a width and a height of a rectangle.

In some implementations, the generating a cropping frame according to a size of a to-be-cropped image and a target size includes: scaling the to-be-cropped image in a case that an aspect ratio of the to-be-cropped image remains unchanged, so that a length of one side of the scaled to-be-cropped image is equal to a length of a corresponding side of the target size, and a length of another side of the scaled to-be-cropped image is greater than a length of another side of the target size; and taking the one side of the scaled to-be-cropped image whose length is equal to the length of the corresponding side of the target size as one side of the cropping frame, and then generating the cropping frame according to the length of the another side of the target size.

In some implementations, the scaling the to-be-cropped image in a case that an aspect ratio of the to-be-cropped image remains unchanged includes: obtaining a first scale by calculating a ratio of a width of the target size to a width of the to-be-cropped image, and obtaining a second scale by calculating a ratio of a height of the target size to a height of the to-be-cropped image; determining a maximum value of the first scale and the second scale as a scale; and scaling the to-be-cropped image according to the scale.

In some implementations, the method further includes: when the aspect ratio of the target size is not in a preset aspect ratio range, before the scaling the to-be-cropped image in a case that an aspect ratio of the to-be-cropped image remains unchanged, performing second correction on the target size so that an aspect ratio of the target size after the second correction is equal to an aspect ratio threshold that is in the preset aspect ratio range and closest to the aspect ratio of the target size, and updating the target size to the target size after the second correction; and after the taking the image block with the highest evaluation score as a target image obtained by cropping, adjusting the size of the target image to the target size before the second correction, and updating the target image to the adjusted target image.

In some implementations, the method further includes: when a deformation scale obtained by dividing the aspect ratio of the to-be-cropped image by an aspect ratio of the target size is not in a preset deformation scale range, before the scaling the to-be-cropped image in a case that an aspect ratio of the to-be-cropped image remains unchanged, performing third correction on the target size so that a deformation scale obtained by dividing the aspect ratio of the to-be-cropped image by an aspect ratio of the target size after the third correction is equal to a deformation scale threshold that is in the preset deformation scale range and closest to the deformation scale obtained by dividing the aspect ratio of the to-be-cropped image by the aspect ratio of the target size, and updating the target size to the target size after the third correction; and after the taking the image block with the highest evaluation score as a target image obtained by cropping, adjusting the size of the target image to the target size before the third correction, and updating the target image to the adjusted target image.

In some implementations, the selecting image blocks from the to-be-cropped image by using the cropping frame includes: selecting, along the another side of the scaled to-be-cropped image, image blocks from the to-be-cropped image by using the cropping frame according to a cropping step.

In some implementations, the cropping step is calculated according to the number of to-be-selected image blocks.

In some implementations, the method further includes: when a ratio of a width of the target size to a width of the to-be-cropped image is greater than or equal to a ratio of a height of the target size to a height of the to-be-cropped image, before the selecting image blocks from the to-be-cropped image by using the cropping frame, counterclockwise rotating the to-be-cropped image by 90 degrees, so as to make the cropping frame select the image blocks in a horizontal direction; and after the taking the image block with the highest evaluation score as a target image obtained by cropping, clockwise rotating the target image by 90 degrees, and updating the target image to the rotated target image.

In some implementations, the composition quality evaluation model is obtained in the following manner: constructing an image-cropped-image sample pair by using an image and a cropped image corresponding to the image, and then training the image-cropped-image sample pair based on a deep learning algorithm to obtain the composition quality evaluation model.

In some implementations, the composition quality evaluation model is obtained in the following manner: extracting an underlying feature reflecting image composition, then training an image classifier based on the underlying feature, and taking the image classifier as the composition quality evaluation model.

In some implementations, an image cropping apparatus is provided, including: a cropping frame generation module, configured to generate a cropping frame according to a size of a to-be-cropped image and a target size; an image block selection module, configured to select image blocks from the to-be-cropped image by using the cropping frame; and a quality evaluation module, configured to evaluate the selected image blocks by using a composition quality evaluation model, and take the image block with the highest evaluation score as a target image obtained by cropping.

In some implementations, the apparatus further includes a first size correction module, configured to: perform first correction on the size of the to-be-cropped image and the target size, and update the size of the to-be-cropped image to the size after the first correction of the to-be-cropped image and the target size to the target size after the first correction; and adjust a size of the target image to the target size before the first correction, and update the target image to the adjusted target image.

In some implementations, the first size correction module is further configured to: correct the size of the to-be-cropped image and the target size to a width and a height of a rectangle.

In some implementations, the cropping frame generation module is further configured to: scale the to-be-cropped image in a case that an aspect ratio of the to-be-cropped image remains unchanged, so that a length of one side of the scaled to-be-cropped image is equal to a length of a corresponding side of the target size, and a length of another side of the scaled to-be-cropped image is greater than a length of another side of the target size; and take the one side of the scaled to-be-cropped image whose length is equal to the length of the corresponding side of the target size as one side of the cropping frame, and then generate the cropping frame according to the length of the another side of the target size.

In some implementations, the cropping frame generation module is further configured to: obtain a first scale by calculating a ratio of a width of the target size to a width of the to-be-cropped image, and obtain a second scale by calculating a ratio of a height of the target size to a height of the to-be-cropped image; determine a maximum value of the first scale and the second scale as a scale; and scaling the to-be-cropped image according to the scale.

In some implementations, the apparatus further includes a second size correction module, configured to: when the aspect ratio of the target size is not in a preset aspect ratio range, perform second correction on the target size so that an aspect ratio of the target size after the second correction is equal to an aspect ratio threshold that is in the preset aspect ratio range and closest to the aspect ratio of the target size, and update the target size to the target size after the second correction; and adjust the size of the target image to the target size before the second correction, and update the target image to the adjusted target image.

In some implementations, the apparatus further includes a third size correction module, configured to: when a deformation scale obtained by dividing the aspect ratio of the to-be-cropped image by an aspect ratio of the target size is not in a preset deformation scale range, perform third correction on the target size so that a deformation scale obtained by dividing the aspect ratio of the to-be-cropped image by an aspect ratio of the target size after the third correction is equal to a deformation scale threshold that is in the preset deformation scale range and closest to the deformation scale obtained by dividing the aspect ratio of the to-be-cropped image by the aspect ratio of the target size, and update the target size to the target size after the third correction; and adjust the size of the target image to the target size before the third correction, and update the target image to the adjusted target image.

In some implementations, the image block selection module is further configured to: select, along the another side of the scaled to-be-cropped image, image blocks from the to-be-cropped image by using the cropping frame according to a cropping step.

In some implementations, the cropping step is calculated according to the number of to-be-selected image blocks.

In some implementations, the apparatus further includes an image rotating module, configured to: when a ratio of a width of the target size to a width of the to-be-cropped image is greater than or equal to a ratio of a height of the target size to a height of the to-be-cropped image, counterclockwise rotate the to-be-cropped image by 90 degrees, so as to make the cropping frame select the image blocks in a horizontal direction; and clockwise rotate the target image by 90 degrees, and update the target image to the rotated target image.

In some implementations, the composition quality evaluation model is obtained in the following manner: constructing an image-cropped-image sample pair by using an image and a cropped image corresponding to the image, and then training the image-cropped-image sample pair based on a deep learning algorithm to obtain the composition quality evaluation model.

In some implementations, the composition quality evaluation model is obtained in the following manner: extracting an underlying feature reflecting image composition, then training an image classifier based on the underlying feature, and taking the image classifier as the composition quality evaluation model.

In some implementations, the one or more programs, when executed by the one or more processors, cause the one or more processors to further perform: performing first correction on the size of the to-be-cropped image and the target size, and updating the size of the to-be-cropped image to the size after the first correction of the to-be-cropped image and the target size to the target size after the first correction; and adjusting a size of the target image to the target size before the first correction, and updating the target image to the adjusted target image.

In some implementations, the one or more programs, when executed by the one or more processors, cause the one or more processors to further perform: correcting the size of the to-be-cropped image and the target size to a width and a height of a rectangle.

In some implementations, the one or more programs, when executed by the one or more processors, cause the one or more processors to further perform: scaling the to-be-cropped image in a case that an aspect ratio of the to-be-cropped image remains unchanged, so that a length of one side of the scaled to-be-cropped image is equal to a length of a corresponding side of the target size, and a length of another side of the scaled to-be-cropped image is greater than a length of another side of the target size; and taking the one side of the scaled to-be-cropped image whose length is equal to the length of the corresponding side of the target size as one side of the cropping frame, and then generating the cropping frame according to the length of the another side of the target size.

In some implementations, the one or more programs, when executed by the one or more processors, cause the one or more processors to further perform: obtaining a first scale by calculating a ratio of a width of the target size to a width of the to-be-cropped image, and obtaining a second scale by calculating a ratio of a height of the target size to a height of the to-be-cropped image; determining a maximum value of the first scale and the second scale as a scale; and scaling the to-be-cropped image according to the scale.

In some implementations, the one or more programs, when executed by the one or more processors, cause the one or more processors to further perform: performing second correction on the target size so that an aspect ratio of the target size after the second correction is equal to an aspect ratio threshold that is in the preset aspect ratio range and closest to the aspect ratio of the target size, and updating the target size to the target size after the second correction; and adjusting the size of the target image to the target size before the second correction, and updating the target image to the adjusted target image.

In some implementations, the one or more programs, when executed by the one or more processors, cause the one or more processors to further perform: when a deformation scale obtained by dividing the aspect ratio of the to-be-cropped image by an aspect ratio of the target size is not in a preset deformation scale range, performing third correction on the target size so that a deformation scale obtained by dividing the aspect ratio of the to-be-cropped image by an aspect ratio of the target size after the third correction is equal to a deformation scale threshold that is in the preset deformation scale range and closest to the deformation scale obtained by dividing the aspect ratio of the to-be-cropped image by the aspect ratio of the target size, and updating the target size to the target size after the third correction; and adjusting the size of the target image to the target size before the third correction, and updating the target image to the adjusted target image.

In some implementations, the one or more programs, when executed by the one or more processors, cause the one or more processors to further perform: selecting, along the another side of the scaled to-be-cropped image, image blocks from the to-be-cropped image by using the cropping frame according to a cropping step.

In some implementations, the cropping step is calculated according to the number of to-be-selected image blocks.

In some implementations, the one or more programs, when executed by the one or more processors, cause the one or more processors to further perform: when a ratio of a width of the target size to a width of the to-be-cropped image is greater than or equal to a ratio of a height of the target size to a height of the to-be-cropped image, counterclockwise rotating the to-be-cropped image by 90 degrees, so as to make the cropping frame select the image blocks in a horizontal direction; and clockwise rotating the target image by 90 degrees, and updating the target image to the rotated target image.

In some implementations, the one or more programs, when executed by the one or more processors, cause the one or more processors to further perform: constructing an image-cropped-image sample pair by using an image and a cropped image corresponding to the image, and then training the image-cropped-image sample pair based on a deep learning algorithm to obtain the composition quality evaluation model.

In some implementations, the one or more programs, when executed by the one or more processors, cause the one or more processors to further perform: extracting an underlying feature reflecting image composition, then training an image classifier based on the underlying feature, and taking the image classifier as the composition quality evaluation model.

In some implementations, a computer-readable medium is provided, storing a computer program, the program, when executed by a processor, implementing the image cropping method provided in the embodiments of this application.

One embodiment in the foregoing invention has the following advantages or beneficial effects: a cropping frame is generated according to a size of a to-be-cropped image and a target size, image blocks are selected from the to-be-cropped image by using the cropping frame, and finally the selected image blocks are evaluated by using a composition quality evaluation model, which achieves intelligent cropping according to content and composition of the to-be-cropped image, and can better resolve the problem of image multi-GrabCut cropping and fully consider the rationality and aesthetics of image composition, so as to acquire the most reasonable region of global composition. The size of the to-be-cropped image and the target size are corrected, so that it is easy to crop images of arbitrary sizes. A scale of the target size is determined, some relatively extreme target sizes are corrected, and a small amount of deformation is introduced to exchange for the integrity of image information, so that the target image obtained by cropping can compromise between the deformation and the integrity of the image information. Some to-be-cropped images meeting a particular condition are rotated and transformed so that the cropping frame selects image blocks in a horizontal direction, which can avoid incomplete cropping information caused by the selection of the image blocks in a vertical direction by the cropping frame, and has a better effect especially on images with relatively single target regions on the horizontal line.

Further effects of non-conventional implementations described above are described in the context of implementations below.

What is claimed is:

1. An image cropping method, comprising:
generating a cropping frame according to a size of a to-be-cropped image and a target size;
selecting image blocks from the to-be-cropped image by using the cropping frame; and
evaluating the selected image blocks by using a composition quality evaluation model, and taking the image block with the highest evaluation score as a target image obtained by cropping.

2. The method according to claim 1, further comprising:
before the generating a cropping frame according to a size of a to-be-cropped image and a target size, performing first correction on the size of the to-be-cropped image and the target size; and
after the taking the image block with the highest evaluation score as a target image obtained by cropping, adjusting a size of the target image to the target size before the first correction.

3. The method according to claim 2, wherein the performing first correction on the size of the to-be-cropped image and the target size comprises:
correcting the size of the to-be-cropped image and the target size to a width and a height of a rectangle.

4. The method according to claim 1, wherein the generating a cropping frame according to a size of a to-be-cropped image and a target size comprises:
scaling the to-be-cropped image in a case that an aspect ratio of the to-be-cropped image remains unchanged, so that a length of one side of the scaled to-be-cropped image is equal to a length of a corresponding side of the target size, and a length of another side of the scaled to-be-cropped image is greater than a length of another side of the target size; and
taking the one side of the scaled to-be-cropped image whose length is equal to the length of the corresponding side of the target size as one side of the cropping frame, and then generating the cropping frame according to the length of the another side of the target size.

5. The method according to claim 4, wherein the scaling the to-be-cropped image in a case that an aspect ratio of the to-be-cropped image remains unchanged comprises:
obtaining a first scale by calculating a ratio of a width of the target size to a width of the to-be-cropped image, and obtaining a second scale by calculating a ratio of a height of the target size to a height of the to-be-cropped image;
determining a maximum value of the first scale and the second scale as a scale; and
scaling the to-be-cropped image according to the scale.

6. The method according to claim 4, further comprising: in response to that the aspect ratio of the target size is not in a preset aspect ratio range,
before the scaling the to-be-cropped image in a case that an aspect ratio of the to-be-cropped image remains unchanged, performing second correction on the target size, so that an aspect ratio of the target size after the second correction is equal to a target aspect ratio threshold that is in the preset aspect ratio range and closest to the aspect ratio of the target size; and
after the taking the image block with the highest evaluation score as a target image obtained by cropping, adjusting the size of the target image to the target size before the second correction.

7. The method according to claim 4, further comprising: in response to that a first deformation scale is not in a preset deformation scale range,
before the scaling the to-be-cropped image in a case that an aspect ratio of the to-be-cropped image remains unchanged, performing third correction on the target size, so that a second deformation scale is equal to a target deformation scale that is in the preset deformation scale range and closest to the first deformation scale, the first deformation scale is a deformation scale obtained by dividing the aspect ratio of the to-be-cropped image by an aspect ratio of the target size, and the second deformation scale is a deformation scale obtained by dividing the aspect ratio of the to-be-cropped image by an aspect ratio of the target size after the third correction; and
after the taking the image block with the highest evaluation score as a target image obtained by cropping, adjusting the size of the target image to the target size before the third correction.

8. The method according to claim 4, wherein the selecting image blocks from the to-be-cropped image by using the cropping frame comprises:
selecting, along the another side of the scaled to-be-cropped image, image blocks from the to-be-cropped image by using the cropping frame according to a cropping step.

9. The method according to claim 8, wherein the cropping step is calculated according to the number of to-be-selected image blocks.

10. The method according to claim 8, further comprising: in response to that a target width ratio is greater than or equal to a target height ratio,
before the selecting image blocks from the to-be-cropped image by using the cropping frame, counterclockwise rotating the to-be-cropped image by 90 degrees, so as to make the cropping frame select the image blocks in a horizontal direction, wherein the target width ratio is a ratio of a width of the target size to a width of the to-be-cropped image, and the target height ratio is a ratio of a height of the target size to a height of the to-be-cropped image; and
after the taking the image block with the highest evaluation score as a target image obtained by cropping, clockwise rotating the target image by 90 degrees.

11. The method according to claim 1, wherein the composition quality evaluation model is obtained in the following manner:
constructing an image-cropped-image sample pair by using an image and a cropped image corresponding to the image, and then training the image-cropped-image sample pair based on a deep learning algorithm to obtain the composition quality evaluation model.

12. The method according to claim 1, wherein the composition quality evaluation model is obtained in the following manner:
extracting an underlying feature reflecting image composition, then training an image classifier based on the underlying feature, and taking the image classifier as the composition quality evaluation model.

13. An image cropping electronic device, comprising:
one or more processors; and
a storage apparatus, configured to store one or more programs,
the one or more programs, when executed by the one or more processors, causing the one or more processors to perform:
generating a cropping frame according to a size of a to-be-cropped image and a target size;
selecting image blocks from the to-be-cropped image by using the cropping frame; and
evaluating the selected image blocks by using a composition quality evaluation model, and taking the image block with the highest evaluation score as a target image obtained by cropping.

14. The electronic device according to claim 13, wherein the one or more programs, when executed by the one or more processors, cause the one or more processors to further perform:
before the generating a cropping frame according to a size of a to-be-cropped image and a target size, performing first correction on the size of the to-be-cropped image and the target size; and
after the taking the image block with the highest evaluation score as a target image obtained by cropping, adjusting a size of the target image to the target size before the first correction.

15. The electronic device according to claim 14, wherein the one or more programs, when executed by the one or more processors, cause the one or more processors to further perform:
correcting the size of the to-be-cropped image and the target size to a width and a height of a rectangle.

16. The electronic device according to claim 13, wherein the one or more programs, when executed by the one or more processors, cause the one or more processors to further perform:
scaling the to-be-cropped image in a case that an aspect ratio of the to-be-cropped image remains unchanged, so that a length of one side of the scaled to-be-cropped image is equal to a length of a corresponding side of the target size, and a length of another side of the scaled to-be-cropped image is greater than a length of another side of the target size; and
taking the one side of the scaled to-be-cropped image whose length is equal to the length of the corresponding side of the target size as one side of the cropping frame, and then generating the cropping frame according to the length of the another side of the target size.

17. The electronic device according to claim 16, wherein the one or more programs, when executed by the one or more processors, cause the one or more processors to further perform:
obtaining a first scale by calculating a ratio of a width of the target size to a width of the to-be-cropped image, and obtaining a second scale by calculating a ratio of a height of the target size to a height of the to-be-cropped image;
determining a maximum value of the first scale and the second scale as a scale; and
scaling the to-be-cropped image according to the scale.

18. The electronic device according to claim 16, wherein the one or more programs, when executed by the one or more processors, cause the one or more processors to further perform:
in response to that the aspect ratio of the target size is not in a preset aspect ratio range, before the scaling the to-be-cropped image in a case that an aspect ratio of the to-be-cropped image remains unchanged, performing second correction on the target size, so that an aspect ratio of the target size after the second correction is equal to a target aspect ratio threshold that is in the preset aspect ratio range and closest to the aspect ratio of the target size; and
after the taking the image block with the highest evaluation score as a target image obtained by cropping, adjusting the size of the target image to the target size before the second correction.

19. The electronic device according to claim 16, wherein the one or more programs, when executed by the one or more processors, cause the one or more processors to further perform:
in response to that a first deformation scale is not in a preset deformation scale range, before the scaling the to-be-cropped image in a case that an aspect ratio of the to-be-cropped image remains unchanged, performing third correction on the target size, so that a second deformation scale is equal to a target deformation scale threshold that is in the preset deformation scale range and closest to the first deformation scale; and
after the taking the image block with the highest evaluation score as a target image obtained by cropping, adjusting the size of the target image to the target size before the third correction.

20. A computer-readable medium, storing a computer program, wherein the program, when executed by a processor, performs the following steps:
generating a cropping frame according to a size of a to-be-cropped image and a target size;
selecting image blocks from the to-be-cropped image by using the cropping frame; and
evaluating the selected image blocks by using a composition quality evaluation model, and taking the image block with the highest evaluation score as a target image obtained by cropping.
